(19) United States
(12) Patent Application Publication
(10) Pub. No.: US 2008/0013130 A1
(43) Pub. Date: Jan. 17, 2008

(54) Destination description generating system and destination description interpreting system

(76) Inventor: Mikio Sasaki, Kariya-city (JP)

Correspondence Address: POSZ LAW GROUP, PLC, 12040 SOUTH LAKES DRIVE, SUITE 101, RESTON, VA, 20191, US

(21) Appl. No.: 11/091,699

(22) Filed: Mar. 29, 2005

(30) Foreign Application Priority Data
Mar. 30, 2004 (JP) 2004-99517

(51) Int. Cl. H04N 1/00

(52) U.S. Cl. 358/440

(57) ABSTRACT

A description generator in a user terminal has a group of destination description dictionaries provided for description categories each constructed by a destination and an expanded destination obtained by expanding the concept of the destination. The description generator describes type information by using vocabularies in the destination description dictionaries. A description interpreter in a central system for interpreting the destination description generated by the user terminal specifies a description category (either a destination or an expanded destination) by determining a dictionary for destination description to which the vocabulary used for describing the type information belongs.

### CROSS REFERENCE TO RELATED APPLICATIONS

This application is based on and incorporates herein by reference Japanese Patent Application No. 2004-99517 filed on Mar. 30, 2004.

### FIELD OF THE INVENTION

The present invention relates to a destination description generating system and a destination description interpreting system for generating and interpreting description for enabling digital contents to be commonly used by various information devices typified by a vehicle-mounted information terminal, a PDA, a cellular phone, a notebook-sized PC, and the like.

### BACKGROUND OF THE INVENTION

In recent years, various studies are being made to enable digital contents to be commonly used in multimedia environment. One of the studies relates to employment of a destination description as a description of a destination as one of items in a user description (profile) in a mobile information communication system (including an in-vehicle device such as a car navigation system). The destination description is described with respect to four description attributes of time information indicative of an estimated arrival time at the destination, position information indicative of a position of the destination, type information indicative of a type (position attribute) of the destination, and name information indicative of a specific name of the destination.

A grammatical form (schema) of the destination description is conformed with the international standard of “destination” in ISO/MPEG-21 Part 7 (Digital Item Adaptation) (refer to, for example, ISO/MPEG/MDS subgroup, “ISO/IEC 21000-7 FDIS Part 7: Digital Item Adaptation,” ISO/IEC JTC 1/SC 29/WG11 N6168, 2004-03-19).

A user description includes various descriptions, and each of the descriptions including the destination description has a peculiar data structure. Consequently, a system for interpreting a user description has to be adapted to each of descriptions, and there is a problem such that a parser as a program for interpreting a description is complicated.

Generally, in a user description of this kind, in the case of describing description attributes (in the above-described destination description, time information, position information, type information, and name information), a vague description and a dropout in the description is not allowed. There is a problem such that flexibility in description is missing.

### SUMMARY OF THE INVENTION

It is an object of the present invention to provide a destination description generating system and a destination description interpreting system, which realize improvement in flexibility in a user description and reduced complexity of a parser.

To achieve the above object, in a destination description generating system of a first invention is provided with the following. When time information of an estimated arrival time at a destination, position information of the position of the destination, type information of a type of the destination, and name information of a specific name of the destination are given, time description generating means generates a description of the time information, position description generating means generates a description of the position information, type description generating means generates a description of the type information, and name description generating means generates a description of the name information. A destination description expressing the destination is thereby generated by the four description attributes (time information, position information, type information, and name information).

The destination description generating system has a dictionary for destination description having a list of vocabularies belonging to each of description categories for each description category constructed by a destination and an expanded destination obtained by expanding concept of the destination. The type description generating means describes the type information by using the vocabulary described in the dictionaries for destination description.

Therefore, when the destination description generated by the destination description generating system of the invention is given, a dictionary for destination description to which a vocabulary used for describing the type information belongs is determined. The description category (either the destination or the expanded destination) can be thereby specified.

That is, according to the invention, it is unnecessary to add a description part dedicated to identify a description category to the data structure (schema) for a destination description. Only by adding a dictionary for destination description, information in various description categories can be described in the same data structure.

As a result, at the time of analyzing a destination description, the same procedure can be used irrespective of the description category of the destination description, so that a parser (program for document analysis) can be made simple.

Since information in various description categories can be described in the same data structure, data described in the data structure can be commonly used among various applications, different media, and different terminals. Thus, interoperability of data can be increased.

A destination as one of description categories of a destination description is not limited to an actual place but may include a virtual place. The virtual place is, specifically, a place which existed in the past but does not exist at present, a place which does not exist at present but may exist in future, or a place existing in contents (such as a movie or drama).

Examples of the expanded destination as a description category are specifications of a situation, a purpose, a state, an information environment, and a desired environment. In addition, a state desired to “achieve (desired to be/desired to do)” by the user, a combination of the states, or the like can be also used as the expanded destination.

The time description generating means may regard, as a present destination, a present position of an agent as an object in a destination description and may regard a position the agent already passed as a past destination. At the time of describing information related to the present position, the time description generating means may thereby describe the present time as the time information and, at the time of describing information related to the passed position, describe the past time as the time information.

That is, in the invention, as time information used for describing time in future such as arrival time, present time and past time can be described. Consequently, the present position and the already passed position can be uniformly handled as destinations. Further, at the time of expressing a destination on the basis of experienced events of the past, the destination can be also indirectly expressed by using a destination description in the past (for example, “valley I visited in spring last year”).

Pattern knowledge may be included as one of the expanded destinations, and a designated name may be described as a vocabulary belonging to the pattern knowledge in the description dictionary related to the pattern knowledge. The Pattern knowledge is constructed by a series of destination descriptions patterned having a relation between an effect and its cause or a sequence relation with respect to matters specified from a preliminarily designated name.

In this case, a series of destination descriptions patterned can be described by a single destination description. Therefore, a description can be simplified and information transmission efficiency can be improved.

The destination description generating system of the invention may include additional description generating means for generating a description of additional information that is useful at the time of applying the destination description.

In this case, in a system using a destination description generated by the destination description generating system of the invention, an application, a use environment, or the like can be accurately selected by referring to the additional information.

The additional information is, specifically, a type of an application using a destination description to which the additional information is added, a type of an agent as a main body of a destination description to which the additional information is added, or the like.

Any object can be used as the agent as long as it can be a main body in a destination description. The agent is not limited to the user but may be a physical object (mobile body, a general object, or the like), an object on a computer, an object in media (such as a character in a movie or animation), resources such as a terminal and a network, contents, digital item, an object which transmits a request and state of the user in place of the user, an object communicating with the user, or the like.

When the specifications (in this case, the number of description attributes) of the destination description are changeable, the additional description generating means may generate, for example, a description by adding the additional information as one of description attributes of the destination description.

In the case such specifications are unchangeable, for example, the additional information may be added to a description generated by the type description generating means or the name description generating means (that is, the additional information is described as part of the type information or name information). Alternatively, the additional information is described so as to be associated with the destination description but separately from the destination description.

A dictionary for an additional description having a list of vocabularies belonging to each of categories of the additional information may be provided for each category, and the additional description generating means may describe the additional information by using the vocabulary described in the dictionary for additional description.

Usually, an input other than a numerical value (input unclearly expressed such as “early morning,” “around seven,” and “around here”) is not permitted as time information and position information in a destination description. In such a case, a party who gives the time information and position information to the system, for example, a user has to convert the vague expression to a numerical expression and supply the data. There is consequently a problem that it needs an effort for an entry.

The destination description generating system according to the invention may include numerical value converting means for converting the time information and the position information into numerical values in the case where the time information and the position information are expressed in forms other than numerical values.

In this case, at the time of supplying time information and position information to the system, a vague description other than a numerical value is allowed. In particular, in a use where the user designates time information and position information, usability can be improved largely.

A destination description interpreting system according to a second invention is provided with the following. A dictionary for destination description is included to have a list of vocabularies described as the type information for each description category constructed by a destination and an expanded destination obtained by expanding concept of the destination. Information extracting means extracts the time information, the position information, the type information, and the name information from an input destination description. Description category specifying means specifies a description category of the destination description on the basis of the dictionary for destination description and the type information extracted by the information extracting means.

Therefore, in the destination description interpreting system of the invention, a description category of a destination description generated by the destination description generating system of the first invention can be accurately determined on the basis of the type information. Further, information (time information, position information, type information, and name information) extracted from the destination description can be classified into description categories and the result can be provided to an apparatus using the extracted information.

The destination description interpreting system according to the invention is further provided with the following. Suppose that a pattern knowledge database is included to store pattern knowledge which is constructed by a series of destination descriptions patterned having a relation between an effect and its cause or a sequence relation with respect to matters specified from a preliminarily designated name and to be set as one of the expanded destinations. In this case, the following process is taken: when the type information extracted by the information extracting means is pattern knowledge, pattern knowledge calling means searches the pattern knowledge database by using name information extracted by the information extracting means, and calls pattern knowledge corresponding to a designated name matching the name information.

That is, the destination description interpreting system of the invention can develop a single destination description whose description category is pattern knowledge, to a series of destination descriptions.

Preferably, the destination description interpreting system according to the invention further includes additional information extracting means. This means is for extracting additional information, which is useful for application of the destination description, from the destination description or a description that is generated in association with the destination description and different from the destination description.

In this case, additional information added by the destination description generating system having the additional description generating means can be extracted. Moreover, by providing the additional information to a system using information extracted from the destination description, the system can accurately select an application, a use environment, and the like.

Addition information extracted by the additional information extracting means may be a type of an application using a destination description to which the additional information is added, or a type of an agent as a main body of a destination description to which the additional information is added.

The destination description interpreting system according to the invention may further include path storing means. This means is for time-sequentially storing information extracted by the information extracting means in accordance with time/space points for each agent as a main body of the destination description. The time/space points are specified by the time information and position information in the extracted information.

Specifically, a destination description can be handled as a point in an arbitrary time/space to which meaning is given by type information and name information and which is defined by time information and position information. By arranging the destination descriptions in time sequence, a travel schedule of the agent, a desired state locus, a travel history, or the like can be expressed. Such a travel history can be used for predicting the state and demand of the agent on the basis of, for example, time periodicity and spatial similarity of the travel history.

The destination descriptions do not always form a single path or locus. A plurality of destination descriptions belonging to the same description category may exist in a plane of the same time zone. Specifically, such a description is expected, for example, when a plurality of travel paths expected for a given condition are expressed or when inquiry information for inquiring a destination adapted to a given condition from a plurality of destinations is expressed.

The destination description interpreting system according to the invention may further include demand determining means for determining a demand of the user in accordance with the information extracted by the information extracting means.

Specifically, when a description for a description attribute is missing, it is assumed that the dropout is reflection of the intention (user demand) of a party who generates the destination description. The demand of the user is thereby determined.

The destination description can be varied. In particular, the description largely varies according to the description category, agent type, and application type. It is consequently preferable that the demand determining means make a different determination in accordance with at least one of a description category of the destination description, the type of the agent as a main body of the destination description, and the type of the application using the destination description.

The demand determining means may include retrieval demand determining means. This means is for determining that a demand of the user is a retrieval demand for retrieving a description attribute, for example, when a description category of the destination description is a destination and a description attribute whose description is missing or vague exists in the description destination.

Specifically, when time information is missing, for example, it is determined that there is a demand for retrieving required time (estimated arrival time) to a place specified by the position information and name information. When position information is missing, for example, it is determine that there is a demand for retrieving a place specified by the name information. When name information is missing, for example, it is determined that there is a demand for retrieving a specific name of the place specified by the position information. In the case where future time is described as the time information and both of the position information and name information is missing or vague, it is determined that there is a demand for retrieving (checking) a schedule (the place the user should be at the time).

As described above, the destination description interpreting system of the invention can determine a demand of the user (or a demand for an agent) from a vague description or an incomplete description. By providing the result of determination to a system of using information extracted from a destination description, the system can be allowed to accurately select an application.

Specifically, on a party that generates a destination description, vague time or place can be designated. On a party that uses the destination description, in response to such a designation, an adapted application can be accurately driven.

When there are two destination descriptions belonging to the same description category and whose time/space points are close to each other, the possibility that agents as main bodies of the destination descriptions are in similar states or have similar demands is high.

The destination description interpreting system according to the invention may further include information compensating means. When information in part of a data profile including the destination description is missing, this means compensates missing information on the basis of information of a given data profile. Here, the given data profile has the same description category and the given data profile's distance on a time/space specified by the time information and the position information is within a preset neighborhood determining value.

The destination description interpreting system according to the invention may further include numerical value converting means for converting the time information and the position information into numerical values in the case where the time information and position information is expressed in a form other than numerical values.

In this case, in a destination description, time information and position information is allowed to be described in a vague form other than a numerical value. Consequently, in a use where the user designates time information and position information, usability can be improved largely. Since it is unnecessary to provide numerical value converting means for the destination description generating system, the destination description generating system can be simplified.

### BRIEF DESCRIPTION OF THE DRAWINGS

The above and other objects, features, and advantages of the present invention will become more apparent from the following detailed description made with reference to the accompanying drawings. In the drawings:

FIG. 1 is a block diagram showing a main part of an application providing system of a first embodiment;

FIG. 2 is an explanatory diagram in which the grammatical form of a destination description is indicated by XML;

FIGS. 3A and 3B are explanatory diagrams showing an outline of a description in a basic dictionary;

FIG. 4 is a flowchart showing the details of a destination description generating process;

FIG. 5 is a flowchart showing the details of a destination description interpreting process;

FIG. 6 is a flowchart showing the details of a demand determining process;

FIG. 7 is an explanatory diagram conceptually illustrating a travel schedule of an agent and a state locus expressed by a plurality of destination descriptions;

FIG. 8 is an explanatory diagram conceptually illustrating a travel schedule and a state locus in the case where descriptions of time information of destination descriptions are in the same time zone;

FIG. 9 is an explanatory diagram illustrating an image of an information providing system;

FIG. 10 is a block diagram showing a main part of an application providing system of a second embodiment;

FIG. 11 is an explanatory diagram illustrating that destinations and purposes of destination descriptions expand in time and space;

FIGS. 12A, 12B, and 12C are explanatory diagrams illustrating examples of a typical action pattern of the user as an object of pattern knowledge;

FIG. 13 is an explanatory diagram illustrating the case where one situation is described by combination of destination descriptions;

FIG. 14 is an explanatory diagram showing the relation among elements used for describing a situation;

FIG. 15 is an explanatory diagram illustrating an example of expansion in which a situation is described by combination of destination descriptions; and

FIGS. 16A to 16C are lists showing a range of application of destination descriptions.

### DETAILED DESCRIPTION OF THE PREFERRED EMBODIMENTS

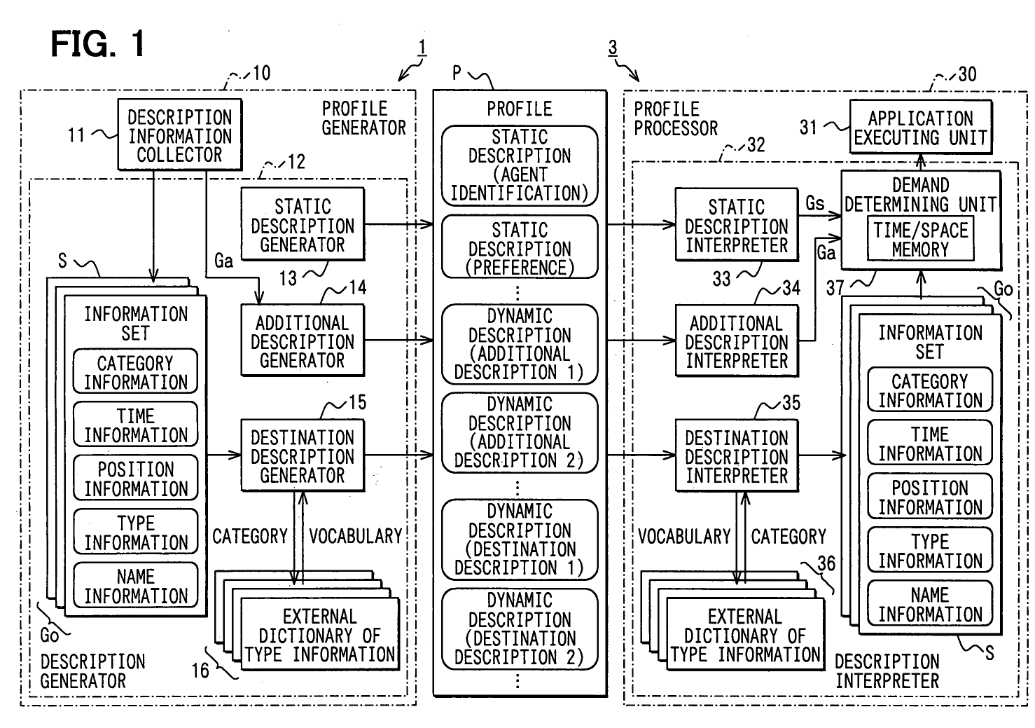

Embodiments of the invention will be described below in conjunction with the drawings. FIG. 1 is a block diagram showing a main part of an application providing system to which a destination description generating system and a destination description interpreting system of the invention are applied.

The application providing system of the embodiment has a user terminal 1 and a central system 3. The user terminal 1 has a profile generator 10 for generating a profile P in which various information of a designated agent is described in accordance with an instruction from the user. The terminal 1 transmits the generated profile P via a communication network (not shown). The central system 3 has a profile processor 30 for executing various applications on the basis of the profile P received via the communication network.

The profile P includes a static description and a dynamic description. The static description is a description of static information which does not normally change such as identification information for identifying each agent and peculiar information indicative of the characteristic of an agent (particularly, when the agent is the user, preference information). The dynamic description is a description of dynamic information which changes from moment to moment such as environment, situation, and phase of an agent; and the situation, demand, and action of the agent.

The dynamic description includes a destination description as a description of the various information, and an additional description as a description of additional information that is useful at the time of using information described as the destination description. In the profile P, the destination description is essential and the additional description is optional. Multiple destination descriptions and multiple additional descriptions may exist.

Examples of the additional information described as an additional description are an agent type (such as “user,” “mobile body,” “object,” and “information”) and an application type (such as “schedule,” “information retrieval,” and “information distribution”) to which information described in the profile P is to be applied.

The various information described as a destination description is classified into a plurality of description categories. One of them is “destination” as an inherent description category of the destination description. The other information includes “purpose,” “state,” and “information environment” as description categories which are set in expanded concept of the destination (they will be also generically called “expanded destination”).

The “destination” can be defined as a “desired space/time point” of the user (agent). The “desired space/time point” in the definition of the “destination” is expanded from just the meaning of “place” to meaning of “a desired state” and “a desired action” of the user (agent). Objects of the state and the action are defined here as “expanded destination.”

As the destination description, basically, information of specifying a time/space point P and the meaning of the time/space point P is described in a lump. Specifically, the destination description is constructed by the following four description attributes.

The description attributes are: time information indicative of time T when the agent exists in the time/space point P; position information indicative of space coordinates of the position (destination) X indicated by the time/space point P, type information indicative of the type of the position X specified by the time/space point P (that is, the details of the destination), and name information indicative of the specific name of the position X specified by the time/space point P.

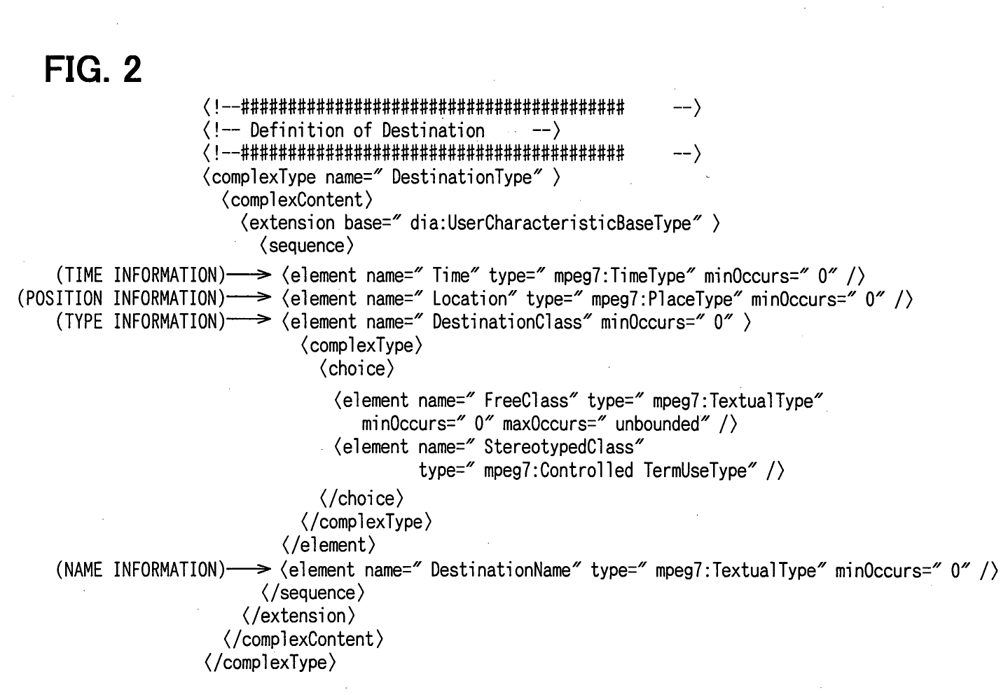

The profile P is described by using XML, and the data structure (description attribute of each piece of data) of the destination description is identified by an XML tag (refer to FIG. 2). The grammatical form (schema) used for the destination description is almost the same as a known international standard of destination in ISO/MPEG-21 Part 7—Digital Item Adaptation.

The time information is described by using numerical data indicative of Greenwich mean time. The position information is described by using numerical data indicative of latitude and longitude. The type information is described by using character data indicative of a pre-defined term (vocabulary). The name information is described by using arbitrary character data. Alternatively, the time information and position information can be also described by using a reserved word (character data) preliminarily associated with numerical data in place of the numerical data. A reserved word such as “waking time,” “tomorrow morning,” “the morning of today,” or the like can be used as the time information. A reserved word such as “home,” “office,” or the like can be used as the position information. The reserved word is not limited to indicate a specific time or position but may have a time width or space width.

In the case where the time T described in the time information indicates time in the future in the destination description, the position X indicated by position information or name information is interpreted as a destination (place at which the user is to arrive). In the case where the time T is present time, the position X is interpreted as the present position. In the case where the time T is time in the past, the position X is interpreted as the destination in the past (travel history).

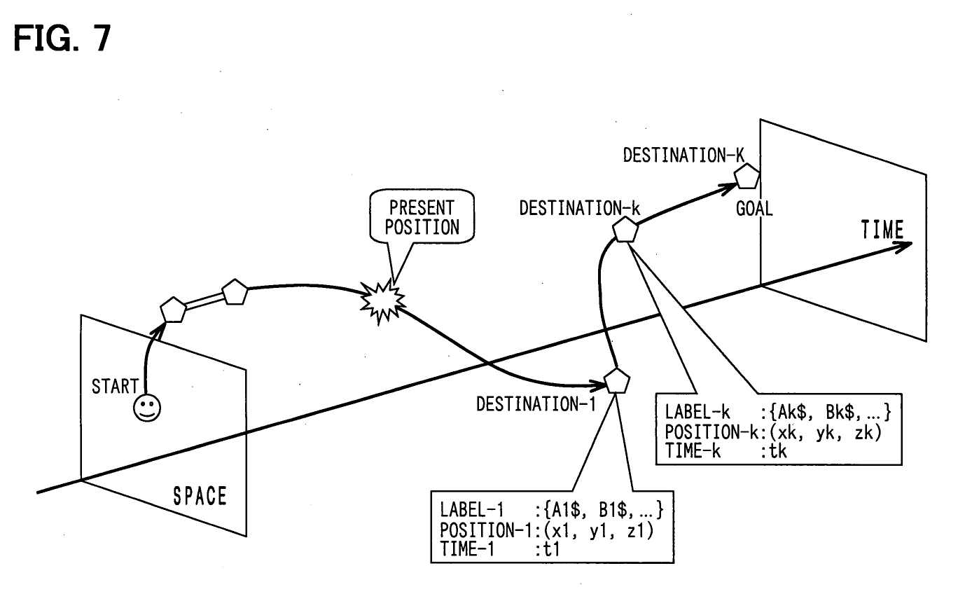

That is, the destination description can be a description of an arbitrary time/space point in the past, at present, or in the future. By combining a plurality of destination descriptions, a travel schedule of an agent as a main body of the destination description, a desired state locus (refer to FIG. 7), and the like can be expressed.

Next, in the user terminal 1, the profile generator 10 has a description information collector 11 and a description generator 12. The description information collector 11 collects information to be described in the profile P on the basis of information collected by using a communication function, an input function, and the like of the user terminal 1 and various operations (such as an input operation) applied on the user terminal 1. The description generator 12 generates a description of the profile P on the basis of the information collected by the description information collector 11 and the like.

Information provided from the description information collector 11 to the description generator 12 is classified into an information group Ga for an additional description and an information group Go for a destination description. The information group Ga for an additional description includes information for specifying a user type and an application type. The information group Go for a destination description includes one or more information sets S each corresponding to one destination description. Each information set S includes the time information, the position information, the type information, the name information and, in addition, category information for specifying a description category that specifies the details of the information.

The description generator 12 has a static description generator 13, an additional description generator 14, a destination description generator 15, and a dictionary group 16 for a destination description. The static description generator 13 generates a static description on the basis of peculiar information (preset static information) Gs of an agent such as identification information of the agent and characteristic (preference) information of the agent. The additional description generator 14 generates an additional description on the basis of the information group Ga for an additional description, which is supplied from the description information collector 11. The destination description generator 15 generates a destination description on the basis of a dictionary group for an additional description (not shown) used when the additional description generator 14 generates an additional description and the information group Go for a destination description supplied from the description information collector 11. The dictionary group 16 for a destination description is used when the destination description generator 15 generates a destination description.

Each of the dictionaries constructing the dictionary group for an additional description is set in correspondence with each of the types of the additional information (agent type and application type). The additional description generator 14 generates an additional description by using a vocabulary described in the dictionary.

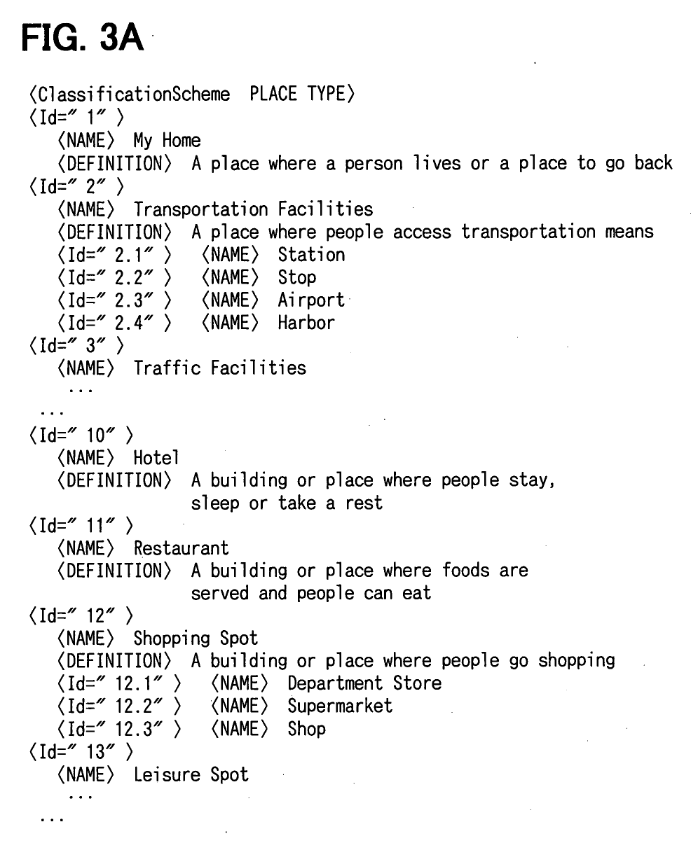

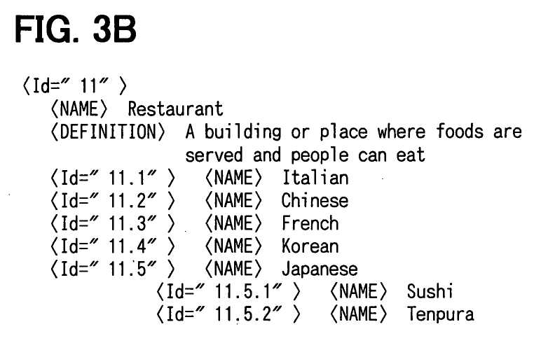

Each of the dictionaries constructing the dictionary group 16 for a destination description is set in correspondence with each of description categories (in this case, “destination,” “purpose,” “state,” and “information environment”). Like the additional description generator 14, the destination description generator 15 generates a destination description, particularly, a description of the type information by using a vocabulary described in the dictionary. The type information includes a fixed class using a vocabulary in a basic dictionary related to “a destination” (refer to FIG. 3A) conformed with an international standard, and a free class using an external dictionary arbitrarily defined between users. FIGS. 3A and 3B show an outline of description contents of a basic dictionary.

The description category “destination” is used in the case of describing a place to which the agent travels (destination), and a specific name of the destination is described as name information.

The description category “purpose” is used in the case of describing the purpose of an action of the agent, and a specific subject matter of the purpose is described as name information.

The description category “state” is used in the case of describing various states of the agent. As the name information, a specific state is described. For example, as a physical state, “healthy,” “headache,” “comfortable,” “uncomfortable,” or the like is described. As a feeling, “calm,” “high-spirited,” “refreshing,” “happy,” or the like is described. As an action, “to watch,” “to know,” “to send,” “to obtain,” or the like is described.

The description category “information environment” is used in the case of describing information that exerts an influence on the action of the agent. As the name information, specific information (for example, “typhoon is approaching the central districts”) is described.

A configuration example (outline) of each of the dictionaries will be described below.

Dictionary for Additional Description
For Agent Type:
{user (office worker, doctor, housewife, student, child, . . . ),
mobile body (car, truck, taxi, train, airplane, . . . ),
object (food, personal computer, car, mail, book, medicine, DVD, . . . ),
information (video, music, urgent information, weather, news, . . . ),
. . . }
For Application Type:
{schedule, information retrieval, information distribution, camera control, drive control, programming of recording of program, . . . }

Dictionary for Destination Description
For destination (fixed class):
{house, office, station, airport, port, restaurant, . . . }
For purpose (free class):
{business, sight seeing, shopping, leisure, sports, learning, transportation, . . . }
For state (free class):
{physical state, mental state, feeling, action, . . . }
For information environment (free class):
{information environment: {weather, air temperature, traffic, finance, economy, politics, . . . }

For a dictionary for the agent type as one of dictionaries for additional description, a vocabulary in superordinate concept such as “user,” “mobile body,” “object,” and “information” and a vocabulary in subordinate concept such as “office worker,” “car,” “food,” and “video” are prepared. Any of the vocabularies may be used.

The description generator 12 with such a configuration generates a description of a profile P by sequentially activating the static description generator 13, additional description generator 14, and destination description generator 15 on the basis of the information groups Ga and Go provided from the description information collector 11 and the preset static information group Gs. The profile P generated by the description generator 12 is transmitted to the central system 3 via the communication network by using the communication function of the user terminal 1.

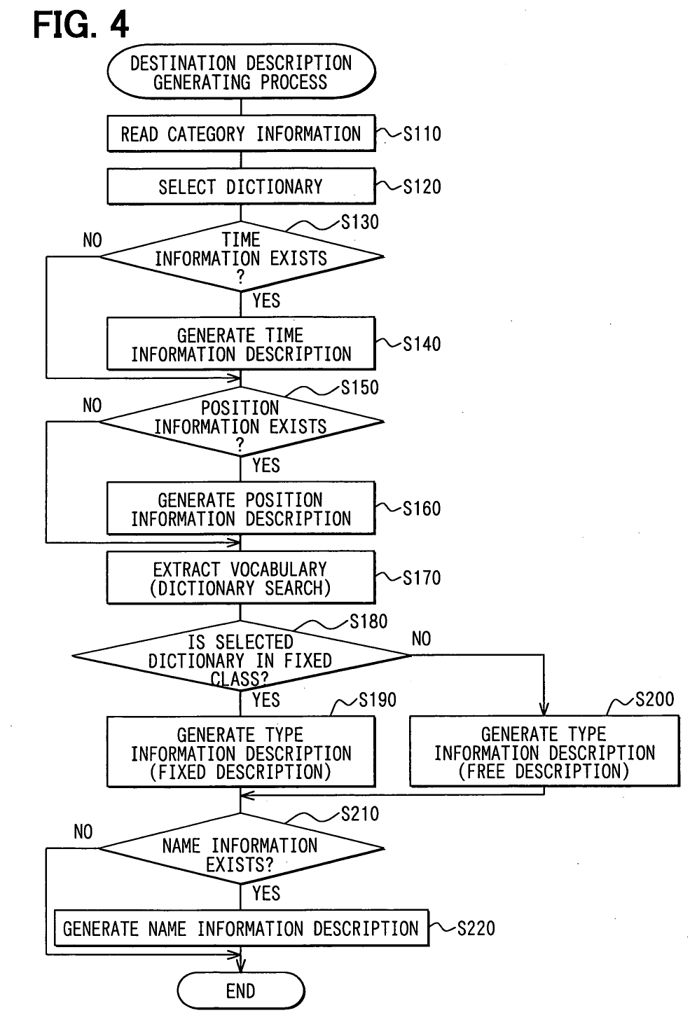

The details of process executed by the destination description generator 15 as a main part of the invention will now be described with the flowchart shown in FIG. 4. The process is started on receipt of the information group Go for destination description provided from the description information collector 11, and is repeatedly executed only by the number of the information sets S constructing the information group Go (the number of destination descriptions to be generated).

As shown in FIG. 4, when the process starts, first, category information is read from the information set S to be processed (S110). On the basis of the category information, a dictionary for destination description to be used at the time of describing type information is selected (S120).

Whether time information is included in the information group Go or not is determined (S130). When time information is included, the time information is read and a description of the time information is generated (S140). When time information is not included, the destination description generator 15 advances to the next step without executing S140. Specifically, a description is generated by generating a tag for a time information description and describing the time information in a position specified by the tag (this will be similarly applied below).

After completion of the process on time information, whether position information is included in the information group Go or not is determined (S150). When position information is included, the position information is read and a description of the position information is generated (S160). When position information is not included, the destination description generator 15 advances to the next step without executing S160.

After completion of the process on the position information, a vocabulary corresponding to the type information read from the information group Go is extracted from the dictionary selected in S120 (S170). Whether the selected dictionary is a dictionary of the fixed class (that is, a dictionary for a destination) or not is determined (S180). When the selected dictionary is a dictionary of the fixed class, a description (fixed description) of type information is generated by using a tag indicating that the dictionary is of the fixed class and the vocabulary extracted from the selected dictionary (S190). When the selected dictionary is not a dictionary of the fixed class, a description (free description) of type information is generated by using a tag indicating that the dictionary is of the free class and the vocabulary extracted from the selected dictionary (S200).

After completion of the process on type information, whether name information is included in the information group Go or not is determined (S210). When name information is included, the name information is read and a description of the name information is generated (S220). After that, the process is finished. When name information is not included, the process is finished without executing S220.

By repeating the process only by the number of information sets S constructing the information group Go for destination description, destination descriptions of the same number are generated as part of the profile P.

As understood from the process, all of the description attributes of a destination description do not have to be always described. The time information, position information, and name information may not be described.

In the central system 3, the profile processor 30 includes: a description interpreter 32 for interpreting the description of the profile P obtained by using the communication function of the center system 3; and an application executing unit 31 for executing various applications in accordance with a result of interpretation of the description interpreter 32.

The description interpreter 32 has a static description interpreter 33, an additional description interpreter 34, a dictionary group (not shown) for additional description used at the time of interpreting a description by the additional description interpreter 34, a destination description interpreter 35, a dictionary group 36 for destination description, and a demand determining unit 37. The static description interpreter 33 carries out interpretation (syntactic analysis) of a static description in the profile P. The additional description interpreter 34 interprets an additional description in the profile P and extracts additional information. The destination description interpreter 35 interprets a destination description in the profile P and extracts various information. The dictionary group 36 for destination description is used at the time of interpreting a description (particularly, type information) in the destination description interpreter 35. The demand determining unit 37 determines a demand of the user who has sent the profile P on the basis of the information groups Gs, Ga, and Go extracted by the description interpreters 33, 34, and 35, respectively, and provides recommendation information of an application adapted to be used for information described in the profile P to the application executing unit 31.

The dictionary group for additional description and the dictionary group 36 for destination description are the same as those of the description generator 12. The demand determining unit 37 has a time/space memory for storing information extracted from the profile P by the interpreters 33 to 35 as a time/space point on time/space coordinates defined by the time information and the position information for each agent.

In the description interpreter 32 with such a configuration, when the profile P is received via a communication network by using the communication function of the central system 3, information described in the profile P is extracted by sequentially starting the static description interpreter 33, additional description interpreter 34, and destination description interpreter 35. After completion of extraction of information by the interpreters 32 to 35, by activating the demand determining unit 37, dropped information is compensated, and application recommendation information is generated. The resultant is supplied together with the information Gs, Ga, and Go extracted from the profile P to the application executing unit 31.

The application executing unit 31 selects an application on the basis of the recommendation information provided from the demand determining unit 37 and the information groups Gs, Ga, and Go, and executes the selected application.

The details of the destination description interpreting process executed by the destination description interpreter 35 and the demand determining process executed by the demand determining unit 37 as a main part of the invention will now be described.

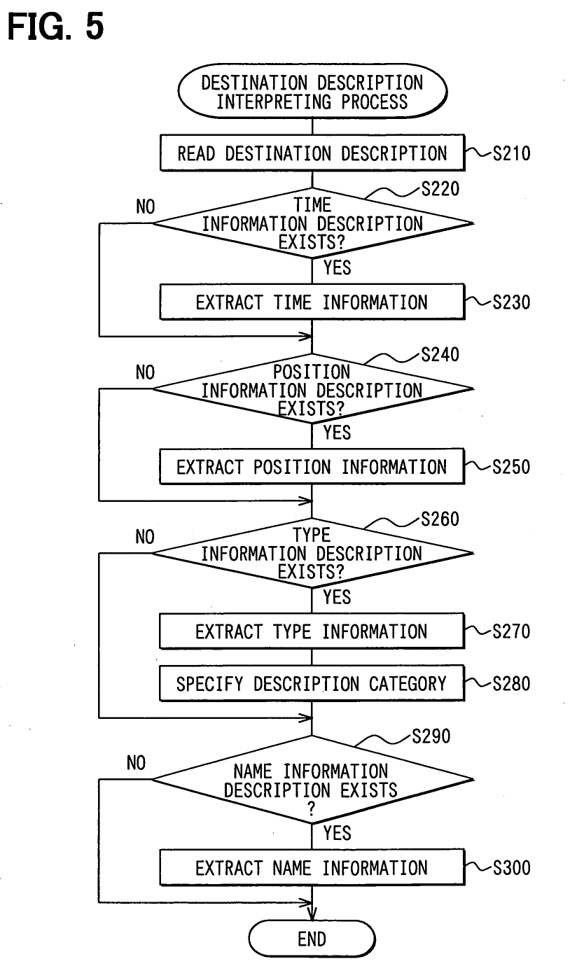

First, the destination description interpreting process will be described with the flowchart of FIG. 5. The process is repeatedly executed only by the number of destination descriptions in the profile P each time the profile P is received.

As shown in FIG. 5, when the process starts, first, a destination description to be processed is read from the profile P (S210). Whether a description of time information exists in the read destination description or not is determined (S220). When a description of time information exists, the described time information is extracted (S230).

Next, whether a description of position information exists in the destination description read in S210 or not is determined (S240). When a description of position information exists, the described position information is extracted (S250).

Whether a description of type information exists in the destination description read in S210 or not is determined (S260). When a description of type information exists, the described type information is extracted (S270). Further, a dictionary to which a term used in the extracted type information belongs is specified by searching the dictionary group 36 for destination description, thereby specifying a description category (S280).

Whether a description of name information exists in the destination description read in S210 or not is determined (S290). When a description of name information exists, the described name information is extracted (S300), and the process is finished.

Each time the process is performed, an information set S of the category information, time information, position information, type information, and name information is obtained. By repeating the process only by the number of destination descriptions existing in the profile P, the information group Go constructed by the information sets S of the number that is the same as the number of destination descriptions existing in the profile P is obtained.

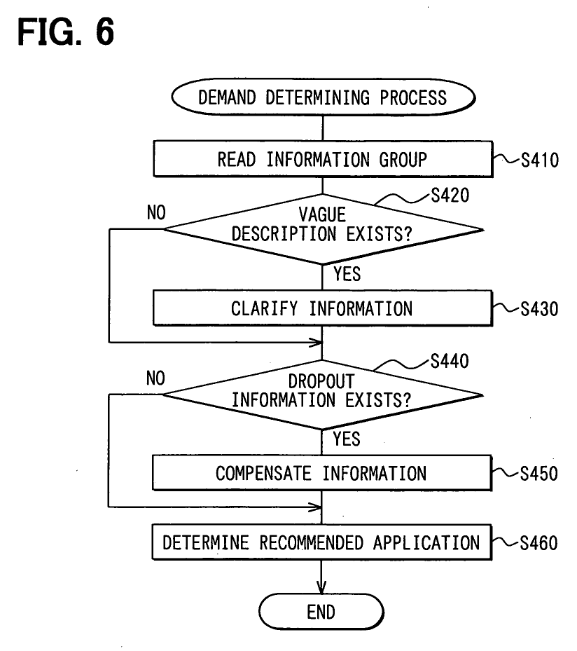

The demand determining process will now be described with the flowchart of FIG. 6. As described above, the process starts on completion of the processes in the interpreters 33 to 35.

As shown in FIG. 6, when the process starts, first, the information groups Gs, Ga, and Go extracted by the interpreters 33, 34, and 35, respectively, are read (S410). Whether a vague description exists in descriptions of information in each of the information sets S constructing the information group Go or not is determined (S420). When there is a vague description, a description clarifying process of clarifying the vague description is executed (S430).

In the description clarifying process, for example, when time information and position information is described in not numerical data but a reserved word, the reserved word is converted to numerical data preliminarily associated with the reserved word. In the case where a description of the name information is vague, the vague description is clarified on the basis of time periodicity and spatial similarity of time/space points in the past which are stored in the time/space memory.

Specifically, when there is a vague description such as “valley I visited in spring last year” as name information in the information set S (refer to the following Description 1), the position and name of the “valley I visited in spring last year” are specified by searching the time/space memory, and compensation of the position information and rewriting of the name information are performed (refer to the following Description 1a).

Description 1

| | |
|---|---|
| Category information: | destination |
| Time information: | not described |
| Position information: | not described |
| Type information: | sightseeing resort |
| Name information: | valley I visited in spring last year |

Description 1a

| | |
|---|---|
| Category information: | destination |
| Time information: | not described |
| Position information: | latitude of xxx degrees, longitude of |
| | yyy degrees |
| Type information: | sightseeing resort |
| Name information: | zzz valley |

Next, whether necessary information is missing in any of the read information groups Gs, Ga, and Go or not is determined (S440). When some of the necessary information is missing, an information compensating process of compensating the missing information is executed (S450).

In the case where a time/space point in the past whose position information and type information match is stored in the time/space memory, the information compensating process is performed to compensate the missing information by using the information related to the time/space point.

Next, a recommended application determining process is performed (S460). An application adapted to use the information indicated in the information groups Go is determined on the basis of the information groups Gs, Ga, and Go (the description contents in the profile P and compensation information) subjected to the clarification and compensation of information. The result of determination is provided together with the information groups Gs, Ga, and Go to the application executing unit 31 (S460), and the process is finished.

In the recommended application determining process, a determination according to the user type and the application type as additional information, the category information in a destination description, and the like is made. Basically, in the case where an application type is included in the information group Ga, an application to be recommended is determined in accordance with the application type. In the case where the description category in the category information is “destination” and any of the time information, position information, type information, and name information is imperfectly described, it is interpreted that a search request for compensating the imperfect description is made, and a search application is recommended.

When type information is described but there is no description specifying a specific place (position information and name information) or a description is vague (refer to the following Description 2), it is interpreted that a search request for specifying a specific position is made. The description is obtained as a result of analysis of the description information collector 11 on the utterance of the user terminal 1 of, for example, “a restaurant around here.”

Description 2

| | |
|---|---|
| Category information: | destination |
| Time information: | not described |
| Position information: | not described |
| Type information: | restaurant |
| Name information: | around here |

When time information is not described but time in future is described as time information (refer to the following Description 3), it is interpreted as a search request whose object to be searched is a place the user can reach by the time or a place available (shop that is open) at the time. The description is obtained as a result of analysis of the description information collector 11 on the utterance of the user of the user terminal 1 of, for example, “a pub around Shinjuku at 7 PM tonight.”

Description 3

| | |
|---|---|
| Category information: | destination |
| Time information: | 7 PM tonight |
| Position information: | not described |
| Type information: | pub |
| Name information: | around Shinjuku |

When there is a description of information (position information, type information, and name information) related to the position of a specific destination but there is no description of time information (refer to the following Description 4), the request is interpreted as a search request of time of arrival at the specifically indicated position (or required time).

Description 4

| | |
|---|---|
| Category information: | destination |
| Time information: | not described |
| Position information: | latitude of xxx degrees, longitude of xxx |
| | degrees |
| Type information: | restaurant |
| Name information: | ZZZ restaurant |

When there is a description of time information but there is no description of information related to the position of a specific destination (position information, name information) (refer to the following Description 5), the request is interpreted as a search request of schedule (destination) of the user (agent). The description is obtained as a result of analysis of the description information collector 11 on utterance of “plan to work at 9 AM tomorrow” of the user of the user terminal 1.

Description 5

| | |
|---|---|
| Category information: | purpose |
| Time information: | 9:00 am of tomorrow |
| Position information: | not described |
| Type information: | business |
| Name information: | not described |

In this case, specific time is described as the time information. In the case where vague time such as “tomorrow morning” is described, the request may be interpreted as a search request whose search range is a preset morning time zone (for example, from 7:00 am to 11:00 am).

When a plurality of information sets having a description equivalent to Description 3 exist (refer to the following Descriptions 6 to 8), the request is interpreted as a series of requests for drawing up a schedule satisfying described conditions. The description is obtained as a result of analysis of the description information collector 11 on utterance of, for example, “library in the morning of Sunday, shopping center at noon, and park at 3 pm” of the user of the user terminal 1.

Description 6

| | |
|---|---|
| Category information: | destination |
| Time information: | in the morning of Sunday |
| Position information: | not described |
| Type information: | library |
| Name information: | not decided yet |

Description 7

| | |
|---|---|
| Category information: | destination |
| Time information: | noon |
| Position information: | not described |
| Type information: | shopping center |
| Name information: | not decided yet |

Description 8

| | |
|---|---|
| Category information: | destination |
| Time information: | 3 pm |
| Position information: | not described |
| Type information: | park |
| Name information: | not decided yet |

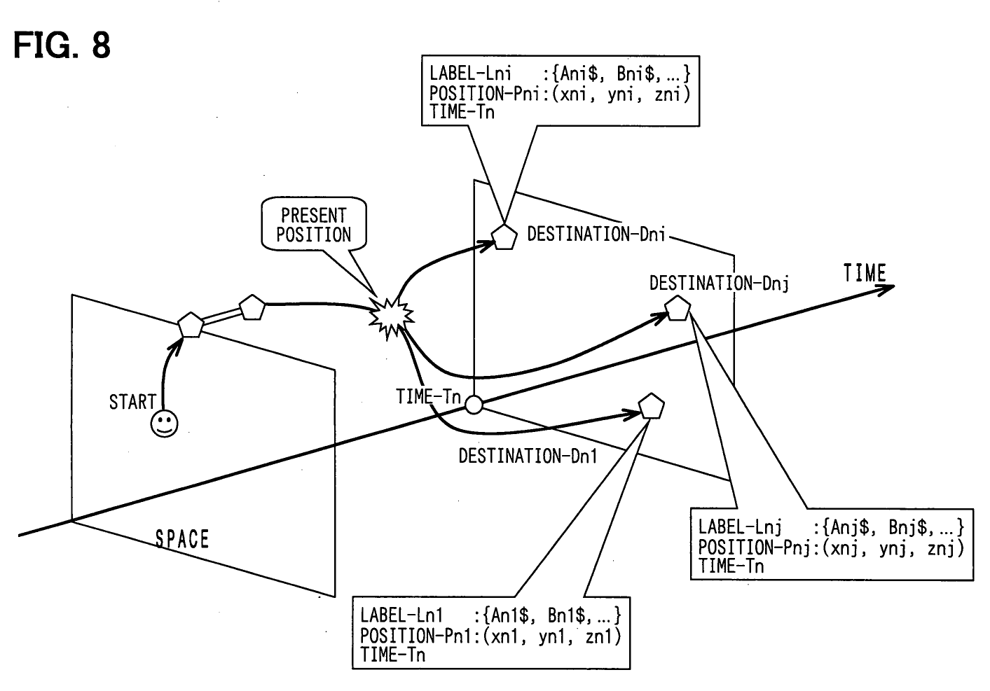

In Descriptions 6 to 8, descriptions of time information are different from each other. When the descriptions of time information are the same (refer to the following Descriptions 9 to 11), as shown in FIG. 8, the information expresses a plurality of travel routes estimated. The request is interpreted as a request for a recommended route or destination in a driving plan, travel plan, or the like. The description is obtained as a result of analysis of the description information collector 11 on utterance of “I plan to go to the Mitake skiing area, Hakucho skiing area, or Disneyland on Saturday of this week” of the user of the user terminal 1.

Description 9

| | |
|---|---|
| Time information: | Saturday of this week |
| Position information: | not described |
| Type information: | skiing area |
| Name information: | Mitake skiing area |

Description 10

| | |
|---|---|
| Time information: | Saturday of this week |
| Position information: | not described |
| Type information: | skiing area |
| Name information: | Hakucho skiing area |

Description 11

| | |
|---|---|
| Time information: | Saturday of this week |
| Position information: | not described |
| Type information: | amusement park |
| Name information: | Disneyland |

As described above, in the application providing system of the embodiment, the description generator 12 of the user terminal 1 has a dictionary for describing a destination for each description category constructed by a destination and an extended destination obtained by extending the concept of the destination. The type information is described by using a vocabulary described in the dictionary for describing a destination.

Therefore, in the description interpreter 32 in the central system 3 for interpreting a destination description generated by the user terminal 1, by checking a dictionary for describing a destination to which the vocabulary used for describing type information belongs, a description category (either a destination or an expanded destination) can be specified.

According to the embodiment, it is unnecessary to add a description part dedicated to identify a description category to a data structure (schema) for describing a destination. Only by adding a dictionary adapted to the description category to the dictionary groups 16 and 36 for describing destination, information of various description categories can be described in the same data structure.

As a result, at the time of analyzing a destination description, the same procedure can be used irrespective of a description category of the destination description. Consequently, a simple parser as a program for executing a process in the destination description interpreter 35, that is, a program for analyzing document can be used.

A destination description which can have the same data structure in various description categories can be applied to various applications, media, and terminals. By employing the destination description as a data specification common to them, data interoperability can be increased.

In the embodiment, a dropout in a description in the profile P and a vague description are allowed and, moreover, a demand of the user who has generated the profile P is determined by positively using a dropout in a description. Thus, a very flexible system can be constructed.

In the embodiment, a destination and an expanded destination to be described is stored as a time/space point having significant description for each agent. Consequently, a set of time/space points of an agent can be regarded as a travel path or a state locus of the agent. As a result, they can be suitably used for an application accompanying various predictions and analogy on the basis of time periodicity and spatial similarity of the travel path and state locus.

### APPLICATION EXAMPLE 1

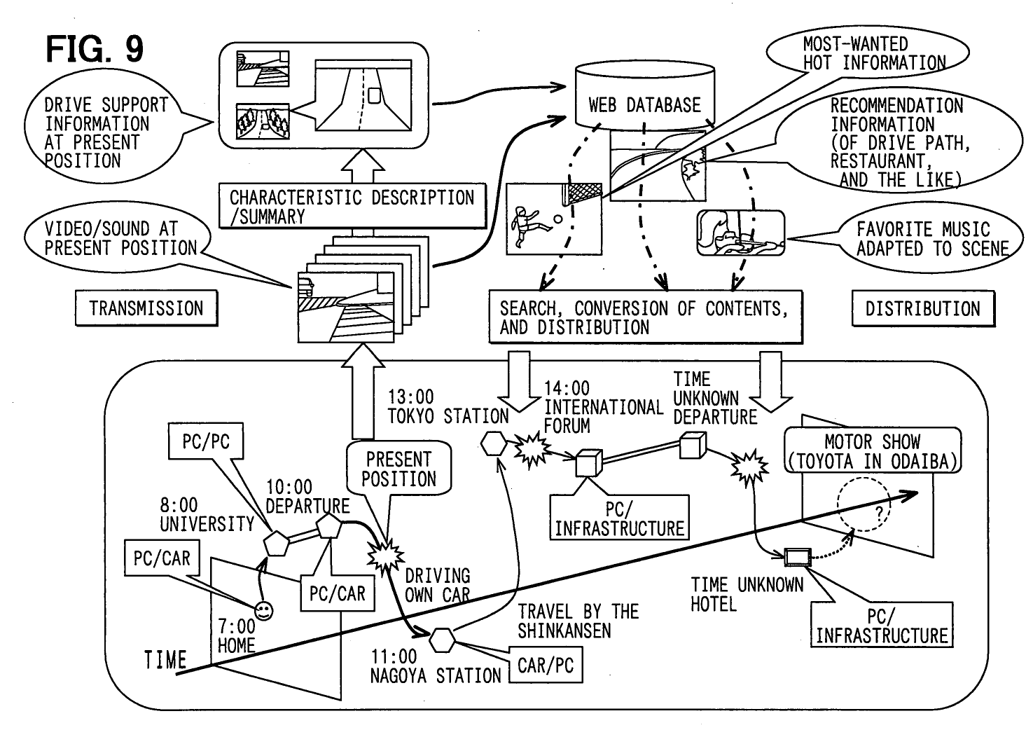

An application example of the application providing system is an information providing system (refer to FIG. 9) of providing various information to an agent who travels in time and space.

In the information providing system, the user terminal 1 registers the profile P in which history of travel and action in the past of an agent and a schedule of travel and action in future are described in a destination description into the center (central system) 3, and properly notifies the central system 3 of the profile P in which the present position (time/space point) and the present state of the agent are described.

When the profile P in which the present position and the present state of the agent are described is received, the central system 3 retrieves registered information of a corresponding position (time/space point) and a corresponding state and starts an application of providing the following information to the user terminal 1.
information regarding the time/space point and state, and information adapted to the time/space point and the state
information subjected to a process (such as characteristic description, summarization, emphasis, or the like) adapted to the time/space point and the state
information having modality (means used at the time of information transmission, such as video image, still picture, sound, and text) and an encoded form adapted to the time/space point and the state
program information of contents (video, sound, and the like) to be obtained in future

Specifically, when the agent is the user, by registering acquisition of desired information (refer to the following Description 12) as one of schedules of the user, it can be set so that desired information is automatically distributed from the central system 3 at desired time. Description 12 is obtained as a result of analysis of the description information collector 11 on, for example, utterance of “Let me know the result of a soccer game at 8 PM tonight” of the user of the user terminal 1.

Description 12

| | |
|---|---|
| Category information: | action |
| Time information: | 8 pm tonight |
| Position information: | not described |
| Type information: | information acquisition |
| Name information: | result of soccer game |

As information distributed from the central system 3, information in a destination description is used. For example, in the case of distributing weather information that “typhoon is approaching the central districts,” the following description may be used.

Description 13

| | |
|---|---|
| Category information: | information environment |
| Time information: | present |
| Position information: | not described |
| Type information: | weather information |
| Name information: | typhoon is approaching the central |
| | districts |

A system can be also constructed as follows. Once the purpose of a travel is described as drive by a destination description and the destination description is registered in the central system 3, each time the profile P indicative of the present position is received from the user terminal 1, the central system 3 automatically distributes and reproduces information that is necessary and optimum for a travel in future (for example, “recommendation information (drive route, restaurant, and the like”) and music and video images adapted to the preference and the state of the driver (agent) described in the profile P and the time/space (for example, “the beach”) during a travel.

For example, in the case where the user is driving a vehicle having a DSRC communication system, when the vehicle passes an infrastructure of the DSRC, information necessary for the user can be distributed at the right timing.

### APPLICATION EXAMPLE 2

As another application example of the application providing system, a probe system (refer to FIG. 9) can be also employed. The probe system collects various information by using an agent (for example, vehicle) traveling in the time/space as a probe.

In the probe system, the user terminal 1 mounted on a vehicle (agent) captures a video image and sound at the present position by using input devices such as a camera and a microphone. The user terminal 1 describes, as a destination description, meta data (including at least information of the present position) of information of the captured video image and sound or information obtained by extracting or summarizing the characteristics of the captured video image and sound, thereby generating the profile P. The user terminal 1 transmits the profile P together with sensing information to the central system 3. The information descried in the profile P is accumulated in the database in the central system 3 as drive support information of the position indicated by the position information (that is, the present position of the user terminal 1).

The drive support information accumulated in the database in the central system 3 is provided in response to a request from an arbitrary user terminal.

The central system 3 that has received the profile P may execute an application of grasping a concentration state of agents (vehicles) in the same time/space on the basis of the sensing information and the information described in the profile P, generating drive support information which makes the agents properly spread, and notifying the users of the agents (vehicles) of the drive support information via the user terminals 1. The central system 3 may execute an application of dynamically controlling a traffic control post on the basis of the drive support information.

By transmitting the sensing information together with the profile P (that is, meta data described in a destination description) to a network in place of accumulating the sensing information in the database in the central system 3, an autonomously information flow of flowing information by driving of the meta data may be realized.

For example, a destination description having a name of “traffic jam information and disaster information at the intersection in front of Shibuya XXX” is generated (refer to the following Description 14) and transmitted to a network. The destination description is automatically distributed to vehicles which seem to pass the Shibuya area within predetermined time (for example, 30 minutes). Consequently, it can urge the drivers of the vehicles to retrieve the information related to the name. In this case, by using an Ad-Hoc network to automatically distribute the information to vehicles, concentration on the center is avoided, and a line trouble can be avoided.

Description 14

| | |
|---|---|
| Category information: | information environment |
| Time information: | present |
| Position information: | not described |
| Type information: | name information |
| Name information: | traffic jam information and disaster |
| | information at the intersection in front of Shibuya |
| | XXX” |

When the probe system is used together with the information providing system of application example 1, to obtain information of an intersection R desired by the driver of a vehicle A, a request (preset) can be made so that a vehicle B which is to pass the intersection R before the vehicle A (specifically, a travel schedule in the destination description includes the intersection R) captures an image at the intersection R.

### APPLICATION EXAMPLE 3

Another application example of the application providing system relates to a device remote control system for controlling a device in a remote place.

For example, in the case of controlling a recorder at home by using the user terminal 1 mounted on a vehicle, the user inputs a demand “for programming to record NHK news at 7 pm tonight” to the user terminal 1 via a user interface (remote control touch panel, sound interaction, or the like). In response to the input, the user terminal 1 generates a profile P including a destination description (refer to the following Description 15) regarding the destination of recording programming information of “the recorder at home” and a destination description (refer to the following Description 16) regarding contents desired to be recorded of “NHK news at 7 pm tonight.” The user terminal 1 transmits the generated profile P to the central system 3 mounted at home.

Description 15

| | |
|---|---|
| Category information: | action/device control |
| Time information: | not described |
| Position information: | home |
| Type information: | programming for recording |
| Name information: | my PC |

Description 16

| | |
|---|---|
| Category information: | specification of desired information |
| | (contents) |
| Time information: | 7 pm tonight |
| Position information: | my PC |
| Type information: | NHK |
| Name information: | news |

By a destination description, a camera in a remote place or during travel can be also controlled to capture an image in a certain place at a certain time. Similarly, a target set state of a camera can be also described.

Further, by setting a target value in a state space by a destination description in a travel control system of a vehicle, a travel state programmed according to the time/space can be also scheduled.

### APPLICATION EXAMPLE 4

Further another application example of the application providing system relates to an information retrieval system for retrieving various information including contents of a video image and music.

In this case, it is sufficient to describe time/space desired to be retrieved as a destination of the destination description. For example, when the user wishes to know “a state of damage by typhoon in Guam in last year,” the following description may be used.

Description 17

| | |
|---|---|
| Category information: | information environment |
| Time information: | last year |
| Position information: | Guam |
| Type information: | information retrieval |
| Name information: | state of damage by typhoons |

In the information retrieval system, not only an existing place but also destinations and states as shown by the following (1) to (3) can be also described as a destination, so that a retrieval of video contents by using a destination description can be realized.

(1) Destination or state in a world captured by contents, that is, a narrative world

Agent on a computer

Characters in contents (such as movie and drama),

Destination in a theme park or an amusement park

(2) Destination or state estimated to exist in future

(3) Destination or state close to desired destination or state, whose existence is unknown

### APPLICATION EXAMPLE 5

Further another application example of the application providing system relates to a physical distribution management system of managing travel and distribution of agents by setting physical objects (such as mobile units, cars, and general objects) as agents.

In this case, a destination description is, for example, destination information (address) described in a tag of an object to be managed. By giving a plurality of destination descriptions to each object, a distribution path of the object, a travel path of a part (object) in an assembly process in a factory, and the like can be described.

An agent as a main body in a destination description is not limited to the user and object but may be an object (device or program) inputting/outputting data in place of the user and communicating with the user, an object on a computer, an object in media (such as a character in a movie or animation), resources such as a terminal and a network, contents, digital item or the like.

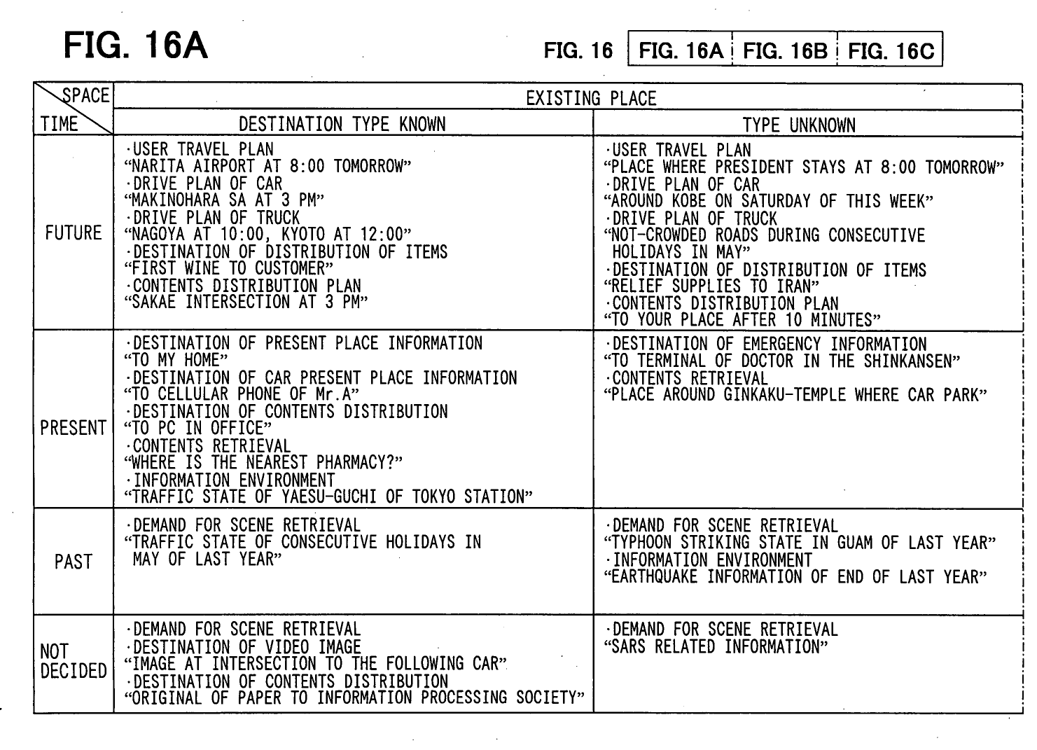

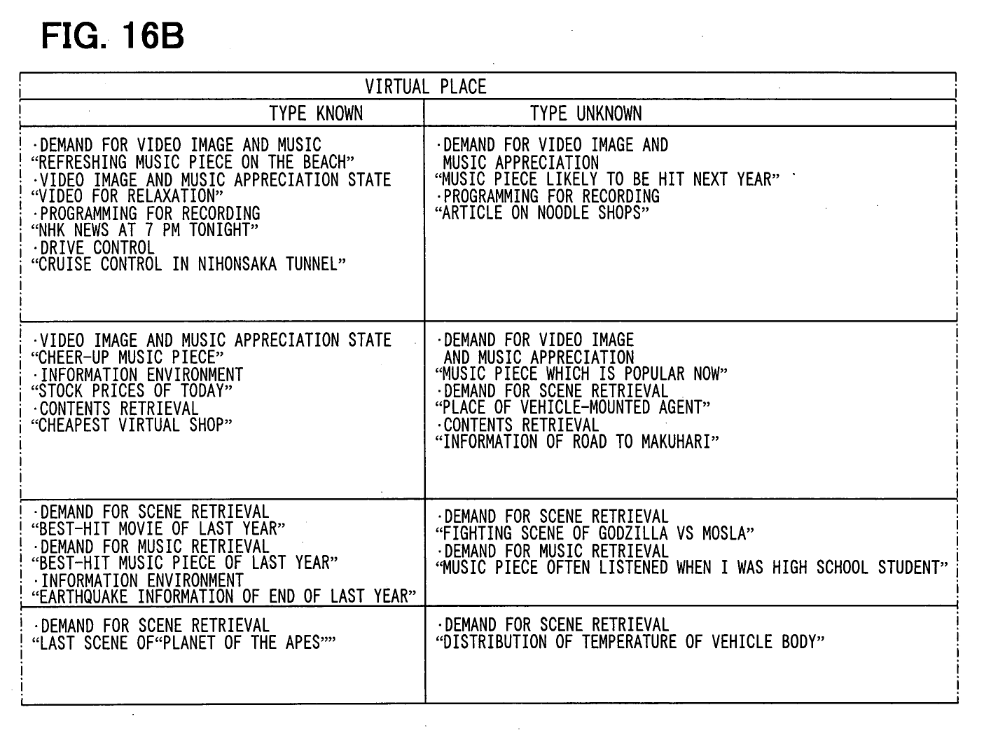

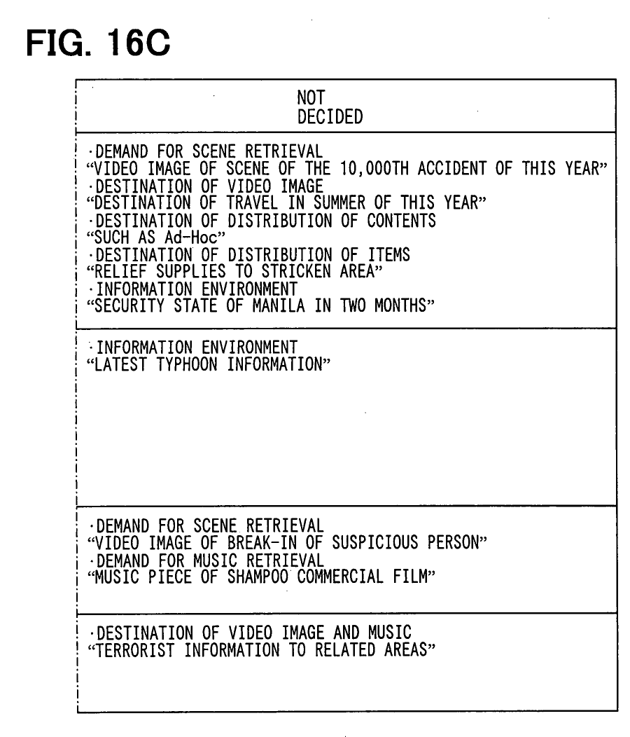

FIGS. 16A to 16C are lists showing another application example of the application providing system. In a conventional destination description, only time in future and existing place are described, so that the destination description can be applied only to the time/space in the column at the left upper corner. It can be understood that, in the embodiment, by expanding time, destination, and agent as objects of a destination description, the application range of the destination description is widened largely.

In the embodiment, S140 corresponds to time description generating means. S160 corresponds to position description generating means. S170 to S200 correspond to type description generating means. S220 corresponds to name description generating means. The additional description generator 14 corresponds to additional description generating means. S430 corresponds to numerical value converting means. S230, S250, S270, and S300 correspond to information extracting means. S280 corresponds to description category specifying means. The time/space memory corresponds to path storing means. S460 corresponds to demand determining means and retrieval request determining means. S450 corresponds to information compensating means.

### Second Embodiment

A second embodiment will now be described.

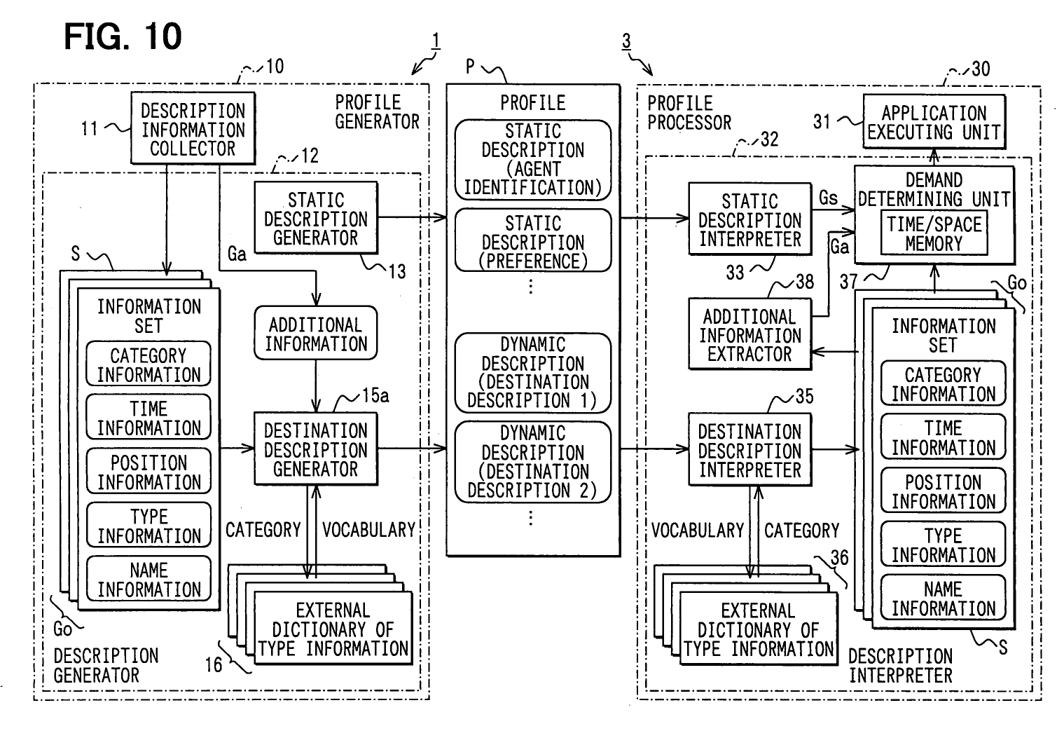

FIG. 10 is a block diagram showing a main part of an application providing system of the second embodiment.

The second embodiment is different from the first embodiment with respect to the profile P transmitted/received between the user terminal 1 and the central system 3; and part of the configuration of the description generator 12 in the user terminal 1 and the description interpreter 32 in the central system 3. The different points will be mainly described.

As shown in FIG. 10, in the embodiment, dynamic descriptions in the profile P are only destination descriptions, and additional descriptions are not included.

The description generator 12 in the user terminal 1 does not include the additional description generator 14. The additional information group Ga from the description information collector 11 is supplied to the destination description generator 15a. Further, the destination description generator 15a is constructed in a manner similar to that in the first embodiment except that the additional information group Ga supplied is described so as to be added to a description of type information or name information. The additional information added to the description of type information and name information is described so as to be identified from the type information or name information and so that the presence or absence of a description can be determined by using a preset sign (parenthesis, colon, or the like).

The description interpreter 32 in the central system 3 does not include the additional description interpreter 34. Instead, the description interpreter 32 has an additional information extractor 38 for extracting the additional information added to the description of the type information or name information from the information set S extracted from the destination description interpreter 35. The demand determining unit 37 is constructed in a manner similar to that of the first embodiment except that it executes a demand determining process with reference to the additional information extracted by the additional information extractor 38.

An example of description of the type information or name information to which the additional information is added is described as follows. Information in parentheses is additional information (an application type and an agent type).
Example 1 . . . Case of adding only application type
home (programming for recording), airport (schedule),
patent office (information retrieval), Nihon-zaka tunnel (drive control)
Example 2 . . . Case of adding application type by combination with agent type
department store (food: delivery), hall (office worker: schedule),
the Tokyo Metropolitan Government (emergency information: information retrieval), Nihon-zaka tunnel (truck: drive control)
Example 3 . . . Case of adding application type by combination with agent type in expression close to natural language
department store (delivery of food), hall (schedule of office worker),
the Tokyo Metropolitan Government (information retrieval of emergency information), Nihon-zaka tunnel (drive control on truck)

As described above, in the embodiment, the additional information is added to the type information or name information of the destination description. Consequently, the configuration of the profile P can be simplified. In addition, the additional description generator 14 in the user terminal 1 and the additional description interpreter 34 in the central system 3 can be omitted, so that the system configuration can be simplified.

In the embodiment, the additional information is added to a description of type information or name information. Alternatively, by expanding the destination description schema, additional information may be described as one of description attributes such as time information, position information, type information, and name information.

In the second embodiment, the additional information extractor 38 corresponds to additional information extracting means.

### Third Embodiment

A third embodiment will now be described.

The third embodiment is constructed in a manner similar to the first embodiment except that the destination description generator 15 has a pattern knowledge database (not shown) for storing a pre-designated name and pattern knowledge associated with the designated name.

The pattern knowledge is a series of destination descriptions patterned having the relation between an effect and its cause or the sequence relation with respect to matters specified from the designated name.

Specifically, a destination (hereinbelow, which includes an expanded destination) is expressed as a point on time/space coordinates (time/space point) as described above. Particularly, in the case where time information or position information of a destination is described by character data (reserved word) not by numerical data, the time range and the space range are widened.

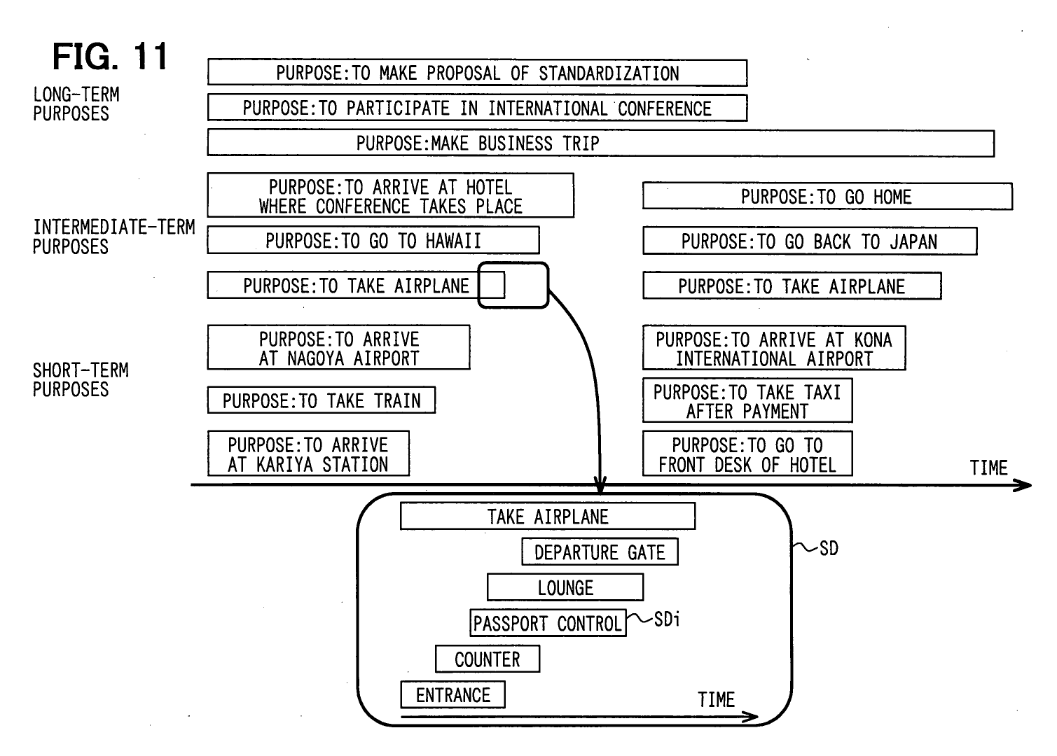

For example, there is a situation such that the user living in the Nagoya area in Japan leaves his/her house for Hawaii for a business trip “to participate in an international conference held in a hotel in Hawaii and make a proposition of standardization” and comes back to his/her house. When the situation is analyzed and arranged on the time base, as shown in FIG. 11, destinations as an object of a destination description in long terms and short terms exist at various levels.

When a destination SD is analyzed (in the diagram, “airplane”), in some cases, the destination SD is constructed by a collection of smaller-scale destinations SDi (“entrance,” “reception,” “passport control,” “lounge,” and “departure gate”). The relation between an effect and its cause or the sequence relation like a pattern from the viewpoint of space exists among the smaller-scale purposes/destinations SDi. A series of destination descriptions on the destinations SDi having such a relation is called pattern knowledge.

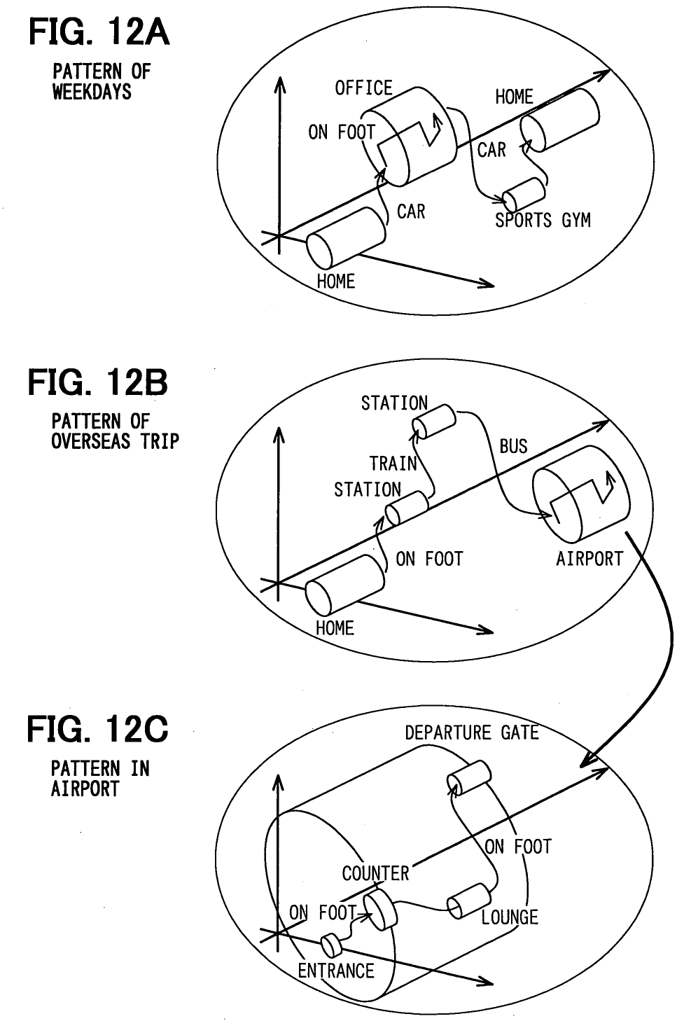

As shown in FIGS. 12A, 12B, and 12C, typical action patterns (such as a weekday pattern and an overseas trip pattern) can be also regarded as pattern knowledge. Particularly, as shown in FIGS. 12B and 12C, the pattern knowledge may have a hierarchical structure.

In the third embodiment, when the type information of the information set S provided from the description information collector 11 is pattern knowledge, the destination description generator 15 in the user terminal 1 searches a pattern knowledge database by using the name information of the same information set S, calls pattern knowledge corresponding to a designated name matching the name information, and generates a series of destination descriptions.

The user terminal 1 is constructed so as to develop the pattern knowledge to a series of destination descriptions at the time of generating the profile P from the information set S.

In the application providing system of the embodiment constructed in such a manner, in the user terminal 1, the description information collector 11 can simply describe the information set S by using the pattern knowledge. Consequently, an effort and the like of the user at the time of inputting information for generating the profile P to the description information collector 11 can be lessened.

By using such pattern knowledge, the system can perform request estimation and information provision (including adaptation of a communication function) more finely and, moreover, can obtain higher compatibility with a natural language description and sound interaction.

Although the pattern knowledge database is provided in the destination description generator 15 in the user terminal 1 in the embodiment, the pattern knowledge database may be provided in the destination description interpreter 35 in the central system 3.

In this case, when the type information extracted from a destination description in the profile P is pattern knowledge, the destination description interpreter 35 searches the pattern knowledge database by using the name information of the same destination description, and calls the pattern knowledge corresponding to the designated name matching the name information. That is, the central system 3 develops the pattern knowledge to a series of destination descriptions at the time of extracting the information set S from the destination description.

As described above, the application providing system of developing the pattern knowledge by the destination description interpreter 35 can describe a series of destination descriptions formed in pattern into a single destination description. Consequently, the scale of the profile P can be suppressed, and efficiency of information transmission from the user terminal 1 to the central system 3 can be improved.

In the embodiment, a process executed by using the pattern information database by the destination description generator 15 and the destination description interpreter 35 corresponds to pattern knowledge calling means.

### Other Embodiments

Although some embodiments of the invention have been described above, the invention is not limited to the foregoing embodiments but can be carried out in various modes.

For example, in the foregoing embodiments, the profile generator 10 and the profile processor 30 are constructed as separate devices in the user terminal 1 and the central system 3, respectively. Alternatively, a single apparatus having both of the profile generator 10 and the profile processor 30 may be constructed.

Communication between the user terminal 1 and the central system 3 can be performed by data transfer in a circuit or software by wire or by wireless. Further, the user terminal 1 and the central system 3 do not always have to perform direct communication. For example, the profile P may be input/output via a portable memory which can be inserted to both of the user terminal 1 and the central system 3.

In the foregoing embodiments, the profile P includes a static description describing static information peculiar to each agent. Otherwise, the static description for specifying the agent may be omitted. For example, in the case where the user terminal 1 is a cellular phone, the central system 3 can specify the agent as a main body of the obtained profile P by information (telephone number or the like) transmitted/received at the time of establishing communication with the central system 3. When all of the static information is registered on the central system 3, the whole static description may be omitted.

In the foregoing embodiments, the additional information is described explicitly in the profile P as an additional description or as an addition to the type information or name information. By classifying the description categories in consideration of the additional information (agent type or application type), the additional information may be transmitted implicitly.

In this case, the number of kinds of the dictionary for destination description increases but the additional description generator 14 and the additional description interpreter 34 are omitted, so that the system can be simplified.

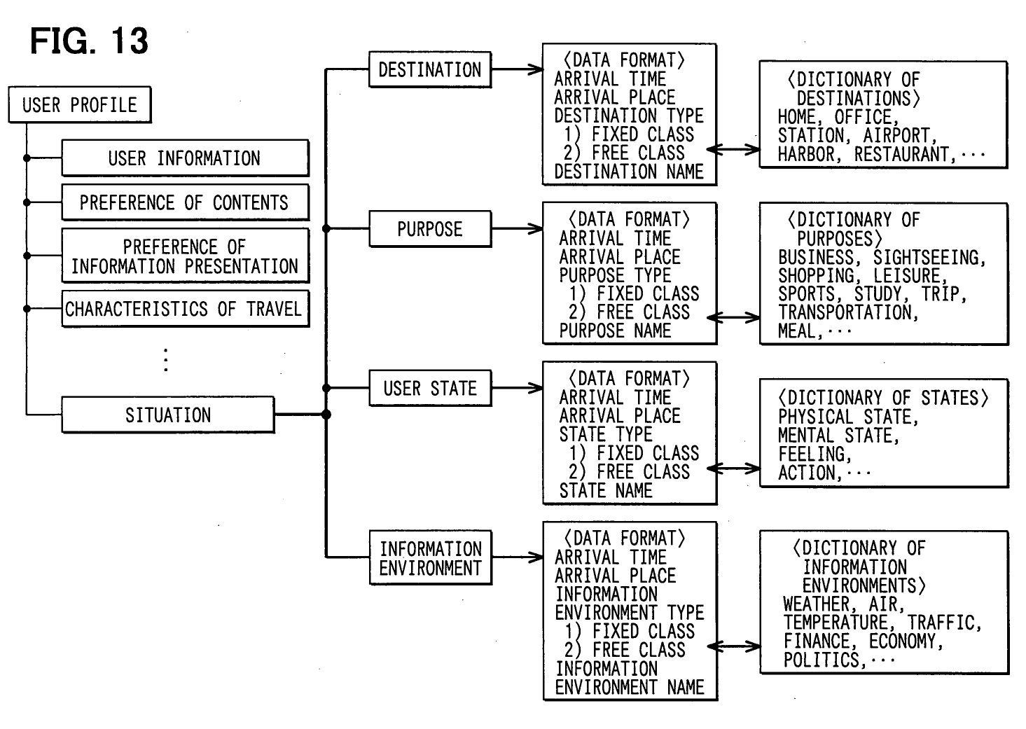

In the foregoing embodiments, a plurality of kinds of description categories of destination descriptions are set and the profile P includes a plurality of destination descriptions described in arbitrary description categories. Alternatively, in the profile P, as shown in FIG. 13, each description category may include a set of four destination descriptions of {destination, purpose, user situation, information environment}. The set of destination descriptions may be defined so as to express one situation of the agent.

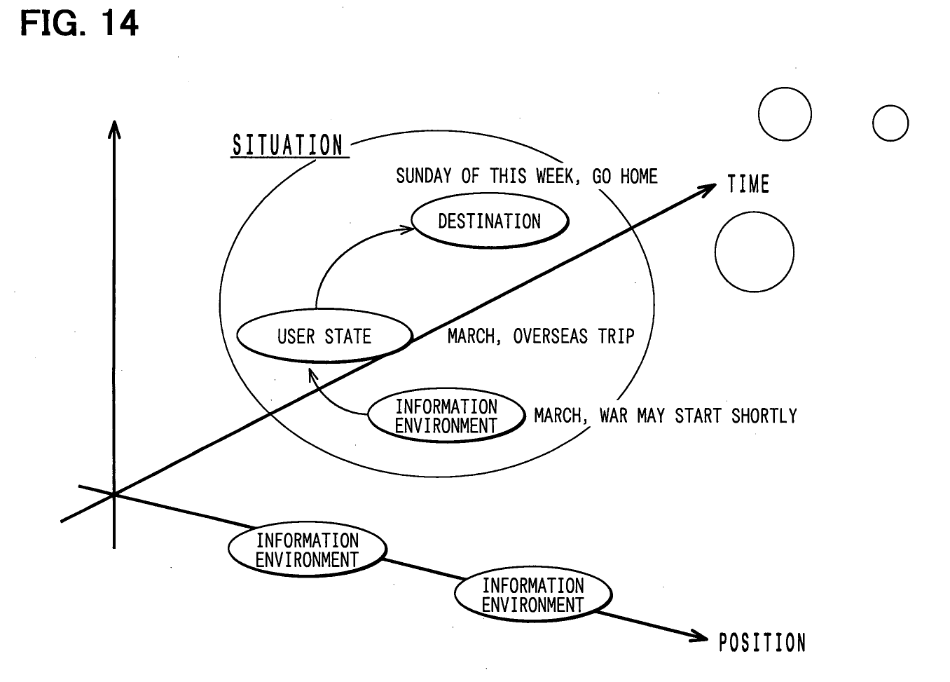

That is, even a single destination can be a dominant factor at the time of performing adaptation of information provision. By also employing the situation, more accurate adaptation becomes possible. FIG. 14 shows the case where the situation of the agent (user) is constructed by {destination, purpose, state, information environment}. Further, in the “situation,” there is a cause-and-effect relation such that the information environment exerts an influence on the user state, and the user state exerts an influence on the destination and purpose.

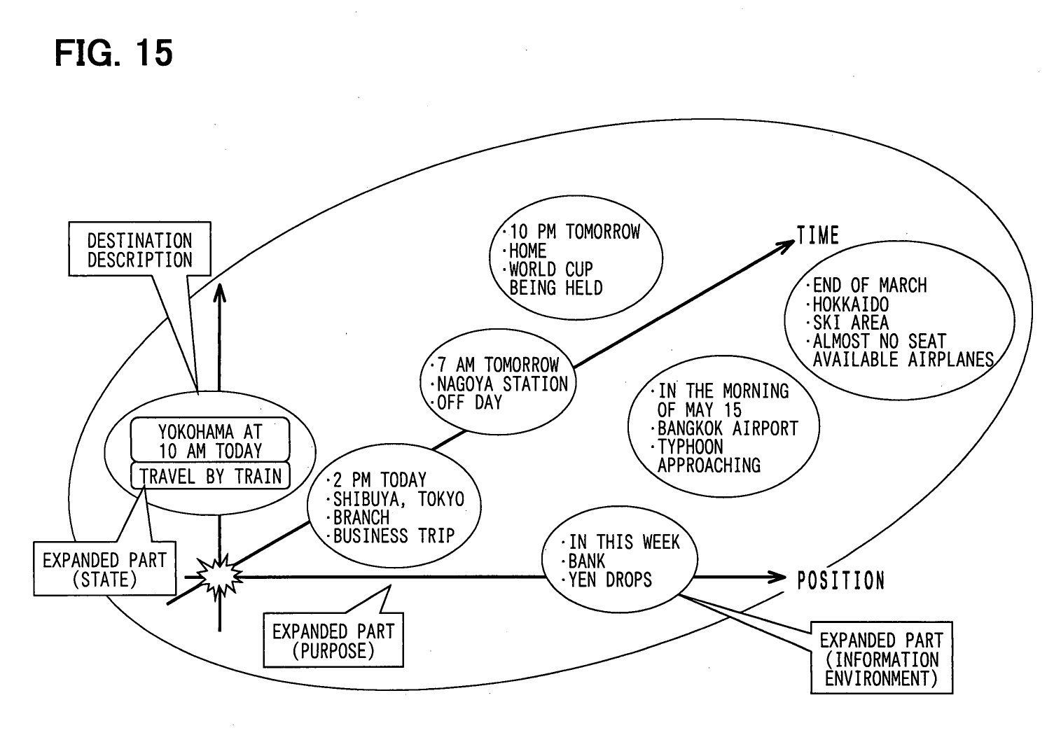

FIG. 15 shows an example of the case of expanding only a destination description to situations. Each situation is a time/space point having a semantic description or a complex of time/space points. By expanding a destination to a situation, information provision which is potentially demanded (or which seems to be demanded) by the user can be grasped more easily.

In the foregoing embodiments, by employing an external dictionary describing an expanded destination in addition to a basic dictionary describing a destination, a description category is expanded. Alternatively, only necessary part in the basic dictionary may be dynamically expanded as shown in FIG. 3B in accordance with the application type or agent type. FIG. 3B shows a case where the basic dictionary is expanded to low-order nodes of a restaurant at the time of guiding restaurants.

At the time of searching a dictionary, nodes may be searched not in order of addresses but in accordance with the preference of the user, day of the week, time zone, or use frequency. In this case, search time can be shortened.

It will be obvious to those skilled in the art that various changes may be made in the above-described embodiments of the present invention. However, the scope of the present invention should be determined by the following claims.

What is claimed is:

1. A destination description generating system for generating a destination description that describes information of a destination with respect to four description attributes of time information, position information, type information, and name information,
the system comprising:
time description generating means for generating a description of time information related to an estimated arrival time at a destination;
position description generating means for generating a description of position information related to a position of the destination;
type description generating means for generating a description of type information related to a type of the destination; and
name description generating means for generating a description of name information related to a specific name of the destination,
wherein a dictionary for destination description having a list of vocabularies belonging to each of description categories is provided for each description category constructed by a destination and an expanded destination obtained by expanding concept of the destination, and
wherein the type description generating means describes the type information by using a vocabulary described in the dictionary for destination description.

2. The destination description generating system according to claim 1,
wherein the destination includes a virtual place.

3. The destination description generating system according to claim 1,
wherein the expanded destination includes at least one of specifications of a situation, a purpose, a state, an information environment, and a desired environment.

4. The destination description generating system according to claim 1,
wherein the time description generating means regards a present position of an agent being an object in a destination description as a present destination, while the time description generating means regards a position that the agent already passed as a past destination, and
wherein the time description generating means describes a present time as the time information when describing information related to the present position, while the time description generating means describes a past time as the time information when describing information related to the position that the agent already passed.

5. The destination description generating system according to claim 1,
wherein pattern knowledge constructed by a series of destination descriptions patterned having a relation between an effect and its cause or a sequence relation with respect to matters specified from a preliminarily designated name is included as one of the expanded destinations, and
wherein the designated name is described as a vocabulary belonging to the pattern knowledge in the description dictionary related to the pattern knowledge.

6. The destination description generating system according to claim 1, further comprising:
additional description generating means for generating a description of additional information that is useful for application of the destination description.

7. The destination description generating system according to claim 6,
wherein the additional description generating means generates a description by adding the additional information as one of description attributes of the destination description.

8. The destination description generating system according to claim 6,
wherein the additional description generating means adds the additional information to a description generated by the type description generating means or the name description generating means.

9. The destination description generating system according to claim 6,
wherein the additional description generating means describes the additional information so as to be associated with the destination description but separately from the destination description.

10. The destination description generating system according to claim 6,
wherein a dictionary for additional description having a list of vocabularies belonging to each of categories of the additional information is provided for each category, and
wherein the additional description generating means describes the additional information by using a vocabulary described in the dictionary for additional description.

11. The destination description generating system according to claim 6,
wherein the additional information is a type of an application using a destination description to which the additional information is added.

12. The destination description generating system according to claim 6,
wherein the additional information is a type of an agent being a main body of a destination description to which the additional information is added.

13. The destination description generating system according to claim 1, further comprising:
numerical value converting means for converting the time information and the position information into numerical values in a case where the time information and the position information are expressed in a form other than the numerical values.

14. A destination description interpreting system for interpreting a destination description which is described with respect to four description attributes of time information related to an estimated arrival time at a destination, position information related to a position of the destination, type information related to a type of the destination, and name information related to a specific name of the destination, comprising:
a dictionary for destination description having a list of vocabularies described as the type information for each description category constructed by a destination and an expanded destination obtained by expanding concept of the destination;
information extracting means for extracting the time information, the position information, the type information, and the name information from an input destination description; and
description category specifying means for specifying a description category of the destination description, based on the dictionary for destination description and the type information extracted by the information extracting means.

15. The destination description interpreting system according to claim 14, further comprising:
a pattern knowledge database for storing pattern knowledge which is constructed by a series of destination descriptions patterned having a relation between an effect and its cause or a sequence relation with respect to matters specified from a preliminarily designated name and is set as one of the expanded destinations; and
pattern knowledge calling means, when the type information extracted by the information extracting means is pattern knowledge, for searching the pattern knowledge database by using name information extracted by the information extracting means and for calling pattern knowledge corresponding to a designated name matching the name information.

16. The destination description interpreting system according to claim 14, further comprising:
additional information extracting means for extracting additional information which is useful for application of the destination description, from the destination description or from a description which is different from the destination description and is generated in association with the destination description.

17. The destination description interpreting system according to claim 16,
wherein additional information extracted by the additional information extracting means is a type of an application using a destination description to which the additional information is added.

18. The destination description interpreting system according to claim 16,
wherein additional information extracted by the additional information extracting means is a type of an agent being a main body of a destination description to which the additional information is added.

19. The destination description interpreting system according to claim 14, further comprising:
path storing means for time-sequentially storing information extracted by the information extracting means in accordance with time/space points specified by the time information and the position information in the extracted information for each agent being a main body of the destination description.

20. The destination description interpreting system according to claim 14, further comprising:
demand determining means for determining a demand of a user in accordance with the information extracted by the information extracting means.

21. The destination description interpreting system according to claim 20,
wherein the demand determining means makes a different determination in accordance with at least one of a description category of the destination description, a type of the agent being a main body of the destination description, and a type of the application using the destination description.

22. The destination description interpreting system according to claim 20,
wherein the demand determining means includes retrieval demand determining means for determining that a demand of the user is a retrieval demand for retrieving a description attribute when a description category of the destination description is a destination and the description attribute whose description is missing or vague exists in the description destination.

23. The destination description interpreting system according to claim 14, further comprising:
information compensating means for compensating, when information in part of a data profile including the destination description is missing, missing information based on information of a data profile that has a same description category and whose distance on a time/space specified by the time information and the position information is within a preset neighborhood determining value.

24. The destination description interpreting system according to claim 14, further comprising:
numerical value converting means for converting the time information and the position information into numerical values in a case where the time information and the position information are expressed in a form other than the numerical values.
